(19) United States
(12) Patent Application Publication
(10) Pub. No.: US 2026/0035548 A1
(43) Pub. Date: Feb. 5, 2026

(54) METHOD OF MAKING PLASTIC BAGS FROM RECYCLED PLASTIC BOTTLES

(71) Applicant: INTERNATIONAL CONSOLIDATED BUSINESS GROUP PTY LTD, Melbourne, VIC (AU)

(72) Inventor: Philip Withers, Victoria (AU)

(21) Appl. No.: 19/099,022

(22) PCT Filed: Jul. 28, 2023
(86) PCT No.: PCT/IB2023/057671

§ 371 Date: Jan. 27, 2025

(30) Foreign Application Priority Data
Jul. 29, 2022 (AU) 2022902133

(51) Int. Cl. C08L 23/06; C08L 23/12; C08L 67/02

(52) U.S. Cl. CPC C08L 23/06; C08L 23/12; C08L 67/02; C08L 2205/025; C08L 2207/062; C08L 2207/066; C08L 2207/20

(57) ABSTRACT

A method of making plastic bags, comprising preparing a mixture comprising about 0.1% to 100% by weight of recycled plastic bottle resin, and forming the mixture into a plastic bag.

### FIELD

The present invention generally relates to a method of making plastic bags from recycled plastic bottles, such as recycled plastic milk bottles.

### BACKGROUND

Consumer focus on recycling is increasing. Single-use plastic bottles are among the most prevalent and visible forms of plastic usage, and also plastic waste. Currently, only a small percentage of single-use plastic bottles are recycled. Consequently, there is a strong association in the mind of the public between plastic bottles, plastic waste, and the need for increased plastic recycling.

Single-use plastic bottles are generally made from four types of plastic materials designated by their plastic resin identification codes, as follows: (1) plastic bottles used to hold potable water and other drinks are typically made from polyethylene terephthalate (PET); (2) high-density polyethylene (HDPE) is used for making rigid plastic bottles such as milk bottles and detergent bottles; (4) low-density polyethylene (LDPE) is used for making squeeze bottles; and (5) polypropylene (PP) is used for pharmaceutical bottles.

Although all plastics used to make plastic bottles can be recycled, the predominant focus in plastic recycling has been making recycled PET (rPET) beverage bottles and recycled HDPE (rHDPE) milk bottles in closed loop “bottle-to-bottle” recycling processes. Bottle-to-bottle recycling typically comprises clean “closed-stream” recycling that involves only one type of recycled plastic—either rPET or rHDPE—having only one colour—clear or green rPET, or white or milky white rHDPE.

There is a technical prejudice against using mixed colour recycled plastic resin in bottle-to-bottle recycling because the presence of black impurities, or blue tints from blue tamper-evident bands left on plastic milk bottles, is perceived as being unclean. In addition, there is a technical prejudice against making plastic milk bottles from rHDPE from plastic milk bottles due to a false perception of residual odour left behind from previous use.

The focus on closed-stream, bottle-to-bottle recycling of plastic bottles is a major barrier to making other plastic products, such as plastic bags, from recycled plastic bottles. In addition, there are a number of technical obstacles that hinder making plastic bags from recycled plastic bottles. Specifically, plastic bags require different functional, physical, physicochemical, and mechanical properties from plastic bottles, and they are made by different manufacturing processes. Plastic milk bottles are made from hard plastics and must be rigid or semi-rigid, whereas plastic bags are made from soft plastics and need to have tensile strength, tear strength, and stretchability. Plastic bottles are generally made by blow moulding, whereas plastic bags are generally made by extrusion. In addition, food contact plastic bags have different chemical compositions and regulatory requirements compared to non-food contact plastic bags.

Furthermore, when two or more recycled plastics derived from plastic bottles are blended together, they are often not compatible with each other. Mixing different types of recycled plastic typically results in lower quality recycled plastic, rendering it too low quality for many end-uses, such as plastic bags. For example, HDPE recyclers lose about 20% of their yield to poor quality due to mixed recycled plastics. Compatibilizer additives have been proposed to enable chemically incompatible plastics to be recycled together, but there is no one-size-fits-all compatibilizer for all recycled plastic combinations. In addition, regulatory approval is required when recycled plastics are used in food contact applications, such as food contact plastic bags.

A further technical obstacle to making food contact plastic bags from food grade recycled plastics is the need for complex and expensive clean recycling technologies to remove contaminants from recycled plastic bottles, such as plastic milk bottles, arising from consumer use and collection.

In view of this background, there is an unmet need for methods of making plastic bags from recycled plastic bottles that preserve the necessary functional properties of plastic bags and which are also cost effective.

### SUMMARY

According to the present invention, there is provided a method of making plastic bags, comprising:
preparing a mixture comprising about 0.1% to 100% by weight of recycled plastic bottle resin;
forming the mixture into a plastic bag.

The recycled plastic bottle resin may comprise one or more of rPET, rHDPE, rLDPE, and rPP.

The mixture may comprise about 30% to about 80% by weight of recycled plastic bottle resin, and a remainder by weight comprising one or more of recycled plastic resin not from recycled plastic bottles, virgin plastic resin, recycled plastic filler, a colour additive, a scent additive, and an odour neutralising additive.

The recycled plastic bottle resin may comprise rHDPE from recycled plastic milk bottles.

The mixture may comprise about 30% to about 50% by weight of rHDPE from recycled plastic milk bottles.

The recycled plastic resin not from recycled plastic bottles may comprise recycled linear low-density polyethylene (rLLDPE).

The recycled plastic filler may comprise recycled calcium carbonate (rCaCO₃).

The plastic bag may comprise a food contact bag, and the recycled plastic bottle resin may comprise food grade rHDPE from recycled plastic milk bottles.

Alternatively, the plastic bag may comprise a non-food contact bag, and the mixture may comprise one or more of a colour additive, a scent additive, an odour neutralising additive, and recycled plastic filler.

The present invention also provides a plastic bag made by the method described above.

### Description of Embodiments

A method of making plastic bags according to embodiments of the present invention may generally start by preparing a mixture comprising about 0.1% to 100% by weight of recycled plastic bottle resin (i.e., post-consumer or recycled plastic resin from recycled plastic bottles). Next, the mixture may be formed into a plastic bag, for example, by melting and extruding into a thin film to make a plastic film bag. The plastic film bag may be monolayer or multilayer. The thin film forming the plastic film bag may have a thickness of about 6 to 100 microns, for example, about 9 to 25 microns. Alternatively, the mixture may be formed into the plastic bag by melting and pressing through rollers to form a thin non-woven fabric to make a non-woven plastic bag.

The mixture, and the resulting plastic bag, may comprise about 30% to about 80% by weight of recycled plastic bottle resin, and a remainder by weight comprising one or more of recycled plastic resin not from recycled plastic bottles, virgin plastic resin (such as, virgin PET, virgin HDPE, virgin LDPE, virgin PP, and virgin LLDPE), recycled plastic filler, a colour additive, a scent additive, and an odour neutralising additive. Optionally, one or more of the colour additive, the scent additive, and the odour neutralising additive may also wholly or partly comprise recycled materials.

The recycled plastic resin not from recycled plastic bottles may, for example, comprise rLLDPE. The recycled plastic filler may, for example, comprise rCaCO₃. The rCaCO₃ may, for example, comprise CaCO₃ ore from a quarry that is initially rejected for its intended industrial use, and is subsequently washed and processed to make it suitable for reuse as rCaCO₃ in recycled plastic bags instead of being rejected and sent back to the quarry to be dumped.

The recycled plastic bottle resin may have a mixed colour from different coloured recycled plastic bottles, for example, grey, black, white, and mixtures thereof. The recycled plastic bottle resin may comprise one or more of rPET, rHDPE, rLDPE, and rPP. The mixture may further comprise a compatibilizer, such as a PE/PP compatibilizer or a PET/PE compatibilizer, when the recycled plastic bottle resin comprises a mixture of rPET and rHDPE or rLDPE, or a mixture of rPP and rHDPE or rLDPE, from mixed recycled plastic bottles.

The recycled plastic bottle resin may, for example, comprise rHDPE from recycled plastic milk bottles. In certain embodiments, the mixture may comprise about 30% to about 50% by weight of rHDPE from recycled plastic milk bottles. Different weight percentages of rHDPE from recycled plastic milk bottles within this range may be used depending on desired functional properties of the plastic bags and cost considerations.

The plastic bags may comprise food contact bags intended to come into contact with food, with or without any type of closure system. The food contact bags may, for example, comprise freezer bags, zipper storage bags, slider storage bags, resealable (or reclosable) bags, fruit and vegetable bags, sandwich bags, gusset bags, flat roll bags, vacuum sealed bags, barrier bags, pouch bags, etc. The closure systems for food contact bags may, for example, comprise zippers, sliders, etc.

When the plastic bag is a food contact bag, the recycled plastic bottle resin may comprise food grade rHDPE from recycled plastic milk bottles. The use of food grade rHDPE may be advantageous for purity and ease of extruding or blowing film with fewer contaminants that break the bubble and stability, and for less actual or perceived odour.

Recycled plastic filler may not be used in the mixture for food grade bags unless it is approved for food contact applications. Furthermore, suitable mixtures for food contact bags may optionally comprise a colour additive, but not comprise a scent additive or an odour neutralising additive.

When the food contact bag comprises a reclosable bag, the closure system may be integrally extruded with the body of the bag if the recycled plastic bottle resin comprises rHDPE and/or rLLDPE. Alternatively, the closure system may be laminated on the body of the bag if the type of recycled plastic bottle resin is not suitable to be integrally extruded. The food contact bag may, for example, comprise a thick slider pouch bag with a stand-up base, such as a stand-up pouch, to replace food containers, or a reclosable bag with a laminated zipper closure system.

Alternatively, the plastic bags may comprise non-food contact bags not intended to come into contact with food, with or without any type of closure system. The non-food contact bags may comprise tidy bags, trash bags, garbage bags, lawn bags, shopping carrier bags, laundry bags, non-woven plastic bags, etc. The closure systems for non-food contact bags may comprise tie handles, draw tapes, wavetop closures, etc.

When the plastic bag is a non-food contact bag, the mixture may comprise one or more of non-food grade rHDPE, rPET, rLDPE, and rPP from respective different types of recycled plastic bottles. Furthermore, suitable mixtures for non-food contact bags may comprise one or more of a colour additive, a scent additive, and an odour neutralising additive. In addition, suitable mixtures for non-food contact bags may comprise recycled plastic filler, such as rCaCO₃.

The following Examples are intended to illustrate the invention. They are not intended to limit the scope of the invention.

### Example 1—Plastic Trash Bags

A 1 kg mixture was prepared containing 800 grams of rHDPE from recycled plastic milk bottles and 200 grams of recycled plastic filler masterbatch. The recycled plastic filler masterbatch contained 160 grams of rCaCO₃, and 40 grams of rHDPE from recycled plastic milk bottles as filler carrier resin. A total of 84% by weight of the mixture therefore comprised recycled plastic bottle resin from recycled plastic milk bottles and, overall, the mixture comprised 100% by weight recycled materials.

The mixture was heated and extruded into plastic film to form plastic trash bags having suitable functional properties and a total recycled content of 100%.

### Example 2—Kitchen Tidy Bags

Kitchen tidy bags were made from a first mixture comprising by weight 30% of rHDPE from recycled plastic milk bottles, 15% virgin HDPE, 5% colour masterbatch, and 50% rHDPE/rLLDPE not from recycled plastic bottles. The resulting kitchen tidy bags had suitable functional qualities and a total recycled content of 80%.

Kitchen tidy bags were also made from a second mixture comprising by weight 30% of rHDPE from recycled plastic milk bottles, 7% rCaCO₃, 3% colour masterbatch, 50% rHDPE not from recycled plastic bottles, and 10% rLLDPE not from recycled plastic bottles. The resulting kitchen tidy bags had suitable functional qualities and a total recycled content of 97%. It is believed that it may be possible to replace the 3% colour masterbatch with a suitable recycled colour additive so that the kitchen tidy bags have a total recycled content of 100%.

### Example 3—Slider Bags

Food contact slider bags were made from a mixture comprising 30% food grade rHDPE from recycled plastic milk bottles, and 70% virgin HDPE and LLDPE resin. The resulting slider bags had suitable functional qualities and a total recycled content of 30%.

### Example 4—Non-Woven Plastic Bags

Non-woven plastic bags were made from a first mixture comprising 100% rPET from recycled water bottles. The resulting non-woven rPET bags had suitable functional qualities and a total recycled content of 100%.

Non-woven plastic bags were also made from a second mixture comprising 100% rPP from recycled water bottles. The resulting non-woven rPP bags had suitable functional qualities and a total recycled content of 100%.

It is believed that it may be more cost effective to make the non-woven plastic bags from rPP because it is less expensive and easier to source compared to rPET. It is also believed that it may be possible to include recycled plastic filler, such as rCaCO₃, in either one of the first and second mixtures to lower costs while preserving necessary functional properties and the total recycled content of 100%.

The invention is not limited to the examples that have just been given. In other words, those skilled in the art will appreciate that the examples may be reproduced without difficulty, and with similar success, by substituting any of the generically or specifically described recycled plastic resins, recycled plastic fillers, process conditions, and sequence of process steps mentioned anywhere in this specification for those actually used in the preceding examples.

Embodiments of the present invention provide a method that is both generally and specifically useful for making plastic bags from recycled plastic bottles.

Unless the context requires otherwise, the word “comprising” means “including, but not limited, to,” and the word “comprises” has a corresponding meaning.

Any reference to prior art is not an admission that the prior art is common general knowledge.

The scope of the invention supported by the above examples is defined by the claims that follow.

1. A method of making plastic bags, comprising:
preparing a mixture comprising about 0.1% to 100% by weight of recycled plastic bottle resin;
forming the mixture into a plastic bag.

2. The method of claim 1, wherein the recycled plastic bottle resin comprises one or more of recycled polyethylene terephthalate (rPET), recycled high-density polyethylene (rHDPE), recycled low-density polyethylene (rLDPE), and recycled polypropylene (rPP).

3. The method of claim 2, wherein the mixture comprises about 30% to about 80% by weight of recycled plastic bottle resin, and a remainder by weight comprising one or more of recycled plastic resin not from recycled plastic bottles, virgin plastic resin, recycled plastic filler, a colour additive, a scent additive, and an odour neutralising additive.

4. The method of claim 3, wherein the recycled plastic bottle resin comprises rHDPE from recycled plastic milk bottles.

5. The method of claim 4, wherein the mixture comprises about 30% to about 50% by weight of rHDPE from recycled plastic milk bottles.

6. The method of claim 3, wherein the recycled plastic resin not from recycled plastic bottles comprises recycled linear low-density polyethylene (rLLDPE).

7. The method of claim 3, wherein the recycled plastic filler comprises recycled calcium carbonate (rCaCO₃).

8. The method of claim 4, wherein the plastic bag comprises a food contact bag, and wherein the recycled plastic bottle resin comprises food grade rHDPE from recycled plastic milk bottles.

9. The method of claim 3, wherein the plastic bag comprises a non-food contact bag, and wherein the mixture comprises one or more of a colour additive, a scent additive, an odour neutralising additive, and recycled plastic filler.

10. A plastic bag made by the method of claim 1.
